(19) United States
(12) Patent Application Publication
(10) Pub. No.: US 2025/0296816 A1
(43) Pub. Date: Sep. 25, 2025

(54) PLANT FOR THE CONSTRUCTION OF ENGINEERING WORKS

(71) Applicant: Deal S.r.l., Pozzuolo Del Friuli (IT)

(72) Inventor: Alessandro ROVERA ROVERA, Magnano In Riviera (IT)

(21) Appl. No.: 18/862,884

(22) PCT Filed: May 5, 2022
(86) PCT No.: PCT/IT2022/000021

§ 371 Date: Nov. 4, 2024

(51) Int. Cl. B66C 23/60; B66C 19/00

(52) U.S. Cl. CPC B66C 23/60; B66C 19/00

(57) ABSTRACT

A plant for the construction, preferably cantilevered, of engineering works which includes a main structure configured to rest, during use, on permanent structures (P) of the engineering work.

### FIELD OF THE INVENTION

The present invention concerns a plant for the construction of engineering works, for example bridges, viaducts, wharfs, quays, etc.

With the present invention, it is possible to operate exclusively from the work under construction, without need for access from below (from the ground or from the water), both for the construction of foundations and for the construction of decks.

The present invention can be applied to any type of foundation construction, for example, direct foundations, foundations on bored piles and/or on driven piles made of concrete and/or steel; it can also be applied to any type of deck construction, for example, made of concrete with prefabricated beams with a slab cast on site or prefabricated, with a caisson with prefabricated segments, prefabricated bi-caissons, of concrete cast on site and/or of steel of any type.

### BACKGROUND OF THE INVENTION

It is known that the construction methods for the construction of engineering works, such as bridges, viaducts, wharfs, quays, etc., mostly provide the following sequence of activities: construction of the foundations, construction of the elevated parts (support structures such as piers, gantries, etc.), generally defined as “substructures”, and construction of the decks, generally defined as “superstructures”. The first two steps generally require the availability of accesses from below, service roads in the case of works on land, or service pontoons in the case of works in water, whether rivers, lakes and/or the sea. Such accesses are necessary in order to have available, on each occasion, specialized equipment necessary for the construction, such as for example pile drivers, drills, clamshell buckets, service cranes for moving the various accessories, reinforcement cages for the formworks, etc., needed for the construction of the substructures (foundation and elevation works).

The need to have access from below is often very burdensome. Consider, for example, the situations in which the work is carried out on lagoons and/or marshes of great environmental interest; or in the case of wharfs at the sea, often associated with the presence of important tidal phenomena where it is not possible to operate continuously both with access from land and from water. In the cases described above it is often necessary, as the only solution, to construct service wharfs in order to build the substructures, definitive foundations and elevation works. Service wharfs are generally made with driven steel piles and steel-wood decks, and are removed upon completion of the work. Apart from the high construction costs, the system just described is in any case conditioned by the possibility of using driven piles at least for the construction of the service wharf, something which is not always possible due to the geotechnical characteristics of the ground.

Construction plants are also known for the construction of bridges, viaducts, wharfs, quays, etc., operating exclusively from the work under construction, but limited only to the case of foundations on driven piles, whether they are made of concrete and/or steel. These plants are divided into two categories:
those that operate with simple overhang;
those that temporarily rest on the ground (generally the seabed).

The former, based on a cantilevered structure of simple conception, generally require very heavy equipment, which makes it impossible to create gaps greater than 30-35 m, in which the loads due to the equipment often represent the decisive load for the design of the whole work. The work is thus sized not for the requirements of the operating phase, but for the construction phase, with a consequent significant increase in costs. Furthermore, generally, these plants are not equipped with lifting systems able to manage the various needs according to the construction system adopted for the construction of the foundations, but only with a device dedicated to the rotation and driving of driven piles. The plant is therefore not applicable in the case of bored piles or other foundation design solutions.

The latter, mostly used in the construction of wharfs at the sea, commonly called “Cantitravel”, also require very heavy and expensive equipment, and in any case depend on the geotechnical characteristics of the ground and also on the meteorological conditions of the sea which can prevent some operations from being carried out. Conventional crawler cranes are generally used, with a weight (including counterweights) in the range of hundreds of tons, so the weight of the truck crane represents the critical load with which all the other components are sized, in particular the support structure and temporary supports (Spud Legs).

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

The present invention provides a plant for the construction, preferably cantilevered, of engineering works. The plant comprises a main structure configured to rest, during use, on at least part of the engineering work, for example on the permanent structures of the engineering work, substructures and/or superstructures.

According to one aspect, the plant comprises a derrick crane constrained to, and integrated with, the main structure.

In some embodiments, the plant mainly comprises:
(a) a main bearing structure consisting of at least two metal structures (caisson and/or lattice) located side by side and connected to each other, on which the following are mounted:
(b) the derrick crane with guyed antenna and special gantry structure so as to allow the feed to the hook from the rear part,
(c) one or more (a pair of) gantry cranes (with or without overhangs) for feeding the derrick crane and/or for the direct installation of the different components of the decks (beams, segments, prefabricated floors, reinforcement cages, etc.),
(d) a forestarling structure able to support:
(e) possible frames for guiding and positioning piles,
(f) a service platform where it is possible to position any type of auxiliary equipment, such as pile drivers, drills, caissons for the disposal of excavated materials;
(g) one or more rest and longitudinal slide units, with or without transverse movement structure, for the equipment to rest on the permanent structures, for the equipment to be inserted on curvilinear layouts and for the repositioning of the equipment itself on the next bay.

The main bearing structure consists of two side by side and parallel structures, located at a distance that is a function of the width of the work, connected to each other in such a way as to constitute a single and rigid system the length of which is equal, for example, to about two and a half times the maximum span of the work to be constructed.

The metal structures can be of the caisson and/or lattice type, depending on the needs of the project. During construction, the main structure is positioned on the last and the penultimate pier, which are made with a rear overhang that allows the gantry cranes to grip the materials (piles, beams, segments, slabs, etc.) and the necessary equipment (drills, pile drivers, casting buckets, etc.).

In some embodiments, rails for the sliding of the gantry crane(s) are positioned on the upper flange of the main structure, while the tracks for the structure to slide on the supports are positioned on the lower flange. Inside the main structure and/or to its side, pipes and/or belts can be conveniently positioned for the disposal of any excavated materials and/or to pump/transport concrete. In addition, service containers, equipment offices and anything else necessary can be housed on special brackets and/or platforms. In particular, on the front part, it is provided to create a large platform, served both by the hook of the derrick crane and also by the hook of the gantry cranes, so as to create optimal operating conditions. On the lower part of the front platform, runways can be housed to hang mobile service platforms for accessing the part of the structure under construction (stripping and/or cutting of the piles, launching and/or casting of pier caps, etc.).

In a preferred embodiment, the derrick crane mainly consists of:
(i) a lattice arm with a gantry-type geometry so as to allow the passage of the feeding gantry cranes;
(ii) vertical antennas provided with a front guy to support the arm and a rear guy for anchoring to the main structure;
(iii) upper crosspiece supporting the lifting tackles which are sliding transversely in such a way as to cover the required width;
(iv) arm retraction winches;
(v) main lifting winch;
(vi) possible secondary lifting winch;
(vii) possible additional guy to support the forestarling of the main structure.

The integration between the main structure and the structure of the derrick crane allows the complete elimination of counterweights (the main structure itself constitutes a counterweight to operating loads) and to have a bearing structure of the “guyed type”, notoriously lighter and more performing. By having the guys, the deformations during construction are exponentially reduced compared to conventional structures, thus ensuring stiffness to the entire system and consequently precision in the operations. When necessary, it is possible to introduce an additional front guy to further limit the deformations.

All of the above allows to make the system conveniently applicable to large spans, up to 60 m, while maintaining the weight of the entire system well below 1000 tons, when the current state of the art considers weights of the order of 1,500-2,000 tons on spans not exceeding 36 m.

According to the present invention, one or more gantry cranes (generally a pair) are installed on the upper part of the structures with the function of moving the materials and the equipment coming from the rear part of the work, supplying in turn the derrick crane and/or definitively positioning the constructive elements of the work.

Together with the main structure, the gantry crane(s) therefore represent the main constituent elements of a conventional “launching car”. With the addition of the necessary known accessories of each construction technology, the plant is able to construct the structure of the decks according to traditionally known methods, for example with prefabricated segments with the “span by span” and/or “balance cantilever” systems, with prefabricated beams with slab cast on site and/or, more conveniently, with entirely prefabricated slab, with entirely prefabricated bi-caissons or multi-caissons, with a mixed steel-concrete structure, with concrete decks cast on site, etc.

In accordance with one aspect of the present invention, the front part of the main structure is equipped with a large service platform on which it is possible to house the special equipment necessary for the construction of the foundation piles which can be, as a non-limiting example:
Driven piles made either of concrete or steel;
Bored piles with temporary or definitive jacket, dug with any type of technology and with any technology for removing excavated materials: traditional, with reverse circulation, etc.

The main structure constitutes a connection between the work front and the part of the engineering work already constructed and therefore accessible with means and equipment. For example, if work is being undertaken in the presence of water and the excavation materials need to be filtered, it is possible to position the necessary equipment (such as for example decantation tanks, continuous cycle filtering systems, etc.) on the engineering work, in the rear part of the equipment, transporting such materials by means of pipes and/or belts conveniently installed inside the main structure and/or to its side.

On the front part of the main structure it is possible to install, on each occasion, as a function of the construction system adopted, the necessary structures for supporting and guiding the piles, in particular in the case of driven and inclined piles often used in the construction of marine wharfs. The considerable stiffness of the guyed structure reduces deformations under the effects of loads to a minimum, despite the system working cantilevered. It is therefore possible to position and guide the piles precisely, ensuring that the required tolerances are respected.

Some embodiments of the present invention also concern one or more rest units consisting of a system of upper roller units/sliders, rotation bases, and under-roller units/sliders. Each rest unit ensures the correct positioning on curvilinear layouts, both during construction and also during the transfer of the equipment itself to the next bay. If necessary, each rest unit can be equipped with engagement/disengagement and/or adjustment hydraulic cylinders. In general, the number of rest units required can be three, in order to allow the repositioning of the supports themselves on the next bay.

The repositioning of the one or more rest units can occur by means of the equipment already present, taking a rest unit from the rear part by means of a gantry crane, which positions it on the front service platform from where the derrick crane provides to re-position it on the front pier just completed. Alternatively, it is possible to create an independent device for repositioning the supports, consisting of craneways suitably installed on the main structure to which, in the repositioning phase, the supports themselves are hung and slide by means of a towing system dedicated to the purpose.

The main advantage of the present invention is that, thanks to the structural integration between the main structure and the structure of the derrick crane, it has been made possible to work cantilevered from the structure just built, without temporary supports, even with significant overhangs and without excessively weighing down the necessary equipment.

The present invention also concerns a design solution for engineering works, for example for bridges, viaducts and wharfs, constructed with prefabricated segments associated directly with the foundation and elevation structure (driven and/or bored piles) integrated with the structural element of the deck (pier head segment). This design solution is particularly suitable for the plant described above, since it allows to significantly reduce the quantities of materials (concrete and reinforcement steel) as well as a decisively optimize construction times.

### DESCRIPTION OF THE DRAWINGS

These and other characteristics of the present invention will become apparent from the following description of some embodiments, given as a non-restrictive example with reference to the attached drawings wherein:

FIG. 1 is a lateral view of a plant in accordance with some embodiments described here;

FIG. 2 is a lateral view of a plant in accordance with other embodiments described here;

FIG. 3 is a view along section III of FIG. 1;

FIG. 4 is a view along section IV of FIG. 1;

FIG. 5 is a front view of a plant in accordance with some embodiments described here;

FIG. 6 is a front view of a plant in accordance with other embodiments described here;

FIG. 7 is a front view of a detail of a plant in accordance with some embodiments described here;

FIGS. 8-13 show a sequence of operation of a plant in accordance with some embodiments described here;

FIG. 14 is a top view of engineering work constructed in accordance with some embodiments described here;

FIG. 15 is a front view, partly sectioned along section XV of FIG. 14;

FIG. 16 is a view along section XVI of FIG. 15.

To facilitate comprehension, the same reference numbers have been used, where possible, to identify identical common elements in the drawings. It is understood that elements and characteristics of one embodiment can conveniently be incorporated into other embodiments without further clarifications.

### DESCRIPTION OF SOME EMBODIMENTS

We will now refer in detail to the possible embodiments of the invention, of which one or more examples are shown in the attached drawings. Each example is supplied by way of illustration of the invention and shall not be understood as a limitation thereof. For example, one or more characteristics shown or described insomuch as they are part of one embodiment can be varied or adopted on, or in association with, other embodiments to produce another embodiment. It is understood that the present invention shall include all such possible modifications and variants.

Before describing these embodiments, we must also clarify that the present description is not limited in its application to details of the construction and disposition of the components as described in the following description using the attached drawings. The present invention can also provide other embodiments and can be produced or executed in various other ways. We must also clarify that the phraseology and terminology used here is for the purposes of description only, and must not be considered as limitative.

The invention concerns a plant 10 for the cantilevered construction of engineering works such as viaducts, bridges, quays, wharfs or suchlike, operating from the work under construction both on dry surfaces and also on aqueous extensions such as rivers, lakes, seas, etc.

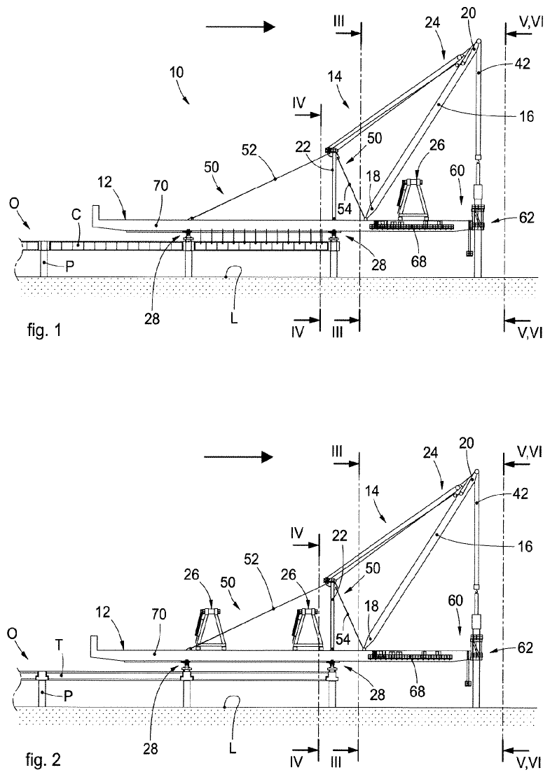

With reference to FIGS. 1 and 2, the plant 10 is shown, on site, resting on permanent bearing structures P, for example piles or piers or decks, of the engineering work O under construction, in particular in correspondence with the last and the penultimate substructure, engaged in the seabed (not shown) and partly emerged from a water level L.

By permanent bearing structures we mean structures on which, during construction, the construction plant can rest and which, once the work is completed, support the deck.

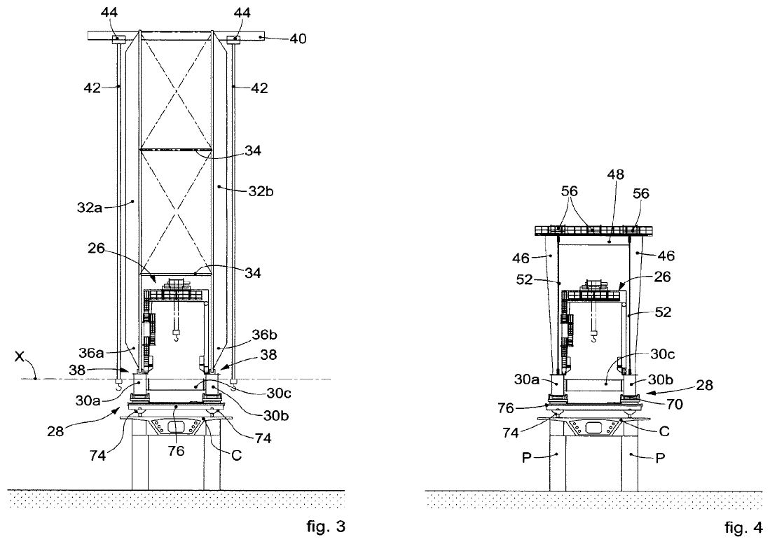

The permanent bearing structures P can be provided as a pair of piers positioned transversely with respect to the longitudinal development of the engineering work O, as visible in FIGS. 3 and 4.

Contiguous permanent bearing structures P are separated by a distance D which substantially corresponds to the bay span of the engineering work O.

The engineering work O used for the description is for illustrative purposes only and must not be construed as limiting the type of engineering work that can be constructed, or of the ground on which such engineering works can be constructed with the embodiments of the plant 10 described here.

The plant 10 comprises a main structure 12 configured to rest, during use, on at least part of the engineering work O. The main structure 12 is provided with a prevalently longitudinal development and has a central part delimited by a head or front part and a tail or rear part, which are defined with respect to the direction of advance of the plant 10 when on site, as identified by the arrow in FIGS. 1 and 2.

The plant 10 can launch decks, for example segments C or beams T, in correspondence with the central part and/or support the formwork in the case of concrete decks cast on site.

The front part, at least on site, can be configured with the necessary equipment to drive or bore the permanent bearing structures P and is typically cantilevered with respect to the engineering work O.

The main structure 12 can have a length equal to at least twice the distance between two permanent bearing structures P or other similar structures.

As a non-limiting example, for the construction of an engineering work O provided with permanent bearing structures P in which the bay span is approximately 40 meters, the main structure 12 can be sized to have a length of approximately at least 80 meters or more, for example 90 meters, 95 meters, 100 meters, 105 meters or 110 meters.

According to the invention, the plant comprises a derrick crane 14 constrained to, and integrated with, the main structure 12. In this way, the structure of the derrick crane 14 itself constitutes an integrating and stiffening part. In particular, the derrick crane 14 is constrained and integrated in correspondence with the front part.

The derrick crane 14 comprises an arm 16 provided with a lower end 18 associated with the main structure 12 and a free opposite upper end 20, at least one support structure 22 with vertical development constrained to the main structure 12, and swing cables 24 that associate the arm 16 with the at least one support structure 22.

The plant 10 can comprise one or more, preferably a pair of, gantry cranes 26, with or without overhangs, for feeding the derrick crane 14 and/or for the direct installation of the various components of the decks (beams, segments, prefabricated floors, reinforcement cages, etc.).

In the case of a pair of gantry cranes 26, these are disposed in succession, substantially on a same axis, along the longitudinal development of the main structure 12.

In order to be sliding, the one or more gantry cranes 26 are associated with the main structure 12 by means of sliders or tracks developed along at least the partial longitudinal development of the main structure 12.

The plant 10 can be provided with the variant with a gantry crane 26 or with a variant with several gantry cranes 26, for example a pair, depending on the type of material that needs to be moved toward the derrick crane 14 or the type of deck that the engineering work O will be provided with.

For example, in the case shown in FIG. 1, in which it is provided to construct an engineering work O with a deck constructed, from pier to pier, with a succession of compact elements joined to each other, for example segments C, one gantry crane 26 can be provided.

In another example, shown in FIG. 2, in which it is provided to construct an engineering work O with a deck constructed, from pier to pier, with one or more longitudinal elements, for example beams T, the variant with a pair of gantry cranes 26 can be preferred.

In the case of several gantry cranes 26, for example a pair, the individual gantry cranes 26 can move in a coordinated manner, for example to transport materials with a predominantly longitudinal or oblong development (for example a beam or a pier) and/or if the weights to be moved are too large for a single gantry crane 26.

Optionally, even in the case of several gantry cranes 26, for example a pair, the individual gantry cranes 26 can move independently.

The main structure 12 comprises two or more rest and slide units 28 configured to associate the plant 10 with the engineering work O in a mobile manner. The two or more rest and slide units 28 can provide support on the permanent bearing structures P and at least longitudinal movement. Optionally, the two or more rest and slide units 28 can be configured to provide transverse movement, and for the insertion on curvilinear layouts and the repositioning of the main structure 12 itself on the next bay.

With reference to FIG. 3, the arm 16 can have a gantry-type geometry in order to provide a gap to allow the passage of the one or more gantry cranes 26.

In particular, the main structure 12 can be made of two metal structures 30a and 30b side by side and stably connected to each other, at least on site, by cross sections 30c in order to create a single structure. The metal structures 30a and 30b can be caisson and/or lattice according to the needs of the individual project.

The arm 16 can be formed by two parallel load bearing structures 32a and 32b with an oblong development, associated with each other by means of one or more connection elements 34 which can be transverse and/or inclined with respect to the two load bearing structures 32a and 32b.

The load bearing structures 32a and 32b can be made in lattice form or in a single block.

A lower end 36a, 36b of each of the two load bearing structures 32a, 32b is associated with the respective part of the metal structure 30a, 30b by connection means 38.

In a variant not shown, the arm 16 can be associated with the cross section 30c. In accordance with this variant, the arm 16 can comprise only one load bearing structure.

The connection means 38 can be, in particular, articulated connection means, more in particular hinge or pivoting means configured to allow the arm 16 to rotate around an axis of rotation X.

In correspondence with the upper end 20, the arm 16 can comprise an upper crosspiece 40 with which one or more lifting lines 42 are associated, used to hook the loads to be moved, for example permanent bearing structures P.

The upper crosspiece 40 can be provided with a track substantially perpendicular to the load bearing structures 32a, 32b, on which there are suitable slide members 44 with which the one or more lifting lines 42 are associated.

With reference to FIG. 4, the at least one support structure 22 can have a gantry or bay type geometry, in which two vertical development elements 46 are joined by a transverse structure 48 in order to form a rigid support structure.

The transverse structure 48 is advantageously positioned at a height such as to form a gap that allows the passage of the one or more gantry cranes 26.

The at least one support structure 22 can be additionally stiffened to the main structure 12 by means of stiffening structures 50, for example guys or struts that allow the main structure 12 to function as a counterweight to the operating loads.

In preferred embodiments, the at least one support structure 22 is associated with the main structure 12 by means of a first pair of guys 52 and a second pair of guys 54 (FIGS. 1 and 2).

In particular, the first pair of guys 52 associates the support structure 22 toward the rear part, while the second pair of guys 54 associates the support structure 22 toward the front part, in order to support the arm 16.

Preferably, the first pair of guys 52 and the second pair of guys 54 are associated in correspondence with an upper end of the at least one support structure 22.

In possible variants, the first pair of guys 52 and the second pair of guys 54 can be separated from each other by an angle of between 70° and 110°.

The plant 10 comprises one or more retraction winches 56, preferably positioned on the transverse structure 48, on which swing cables 39 are wound. The drive of the retraction members 56 allows the movement of the arm 16 around the axis of rotation X.

The one or more retraction winches 56 are connected to at least one motor unit (not shown) to make the one or more retraction winches 56 move. In accordance with possible variants, the one or more retraction winches 56 can be positioned on the transverse structure 48.

The derrick crane 14 also comprises at least one main lifting winch (not shown) and optionally at least one secondary lifting winch, which are associated with the one or more lifting lines 42. The at least one main lifting winch, and possibly the optional at least one lifting winch, are connected to a motor unit (not shown) configured to make them rotate and consequently move the one or more lifting lines 42 (with or without load).

The main structure 12 can comprise a forestarling structure 60 able to support a possible frame for guiding and positioning piles 62.

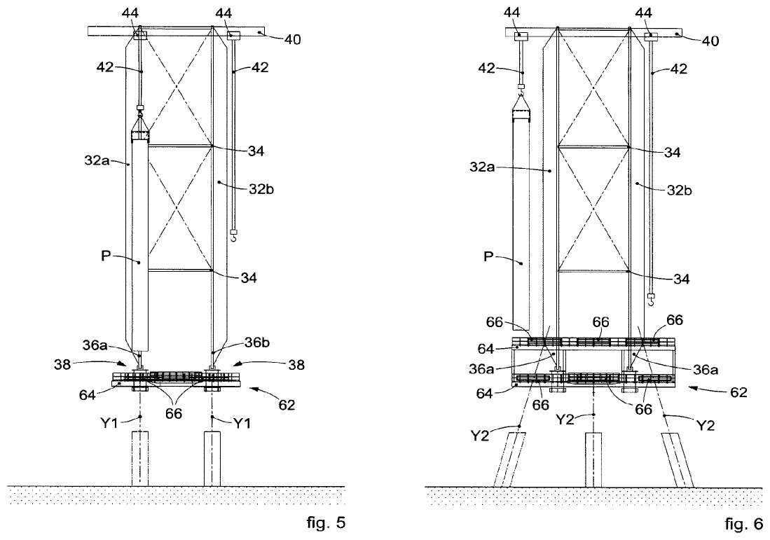

In possible variants, the frame for guiding and positioning piles 62 comprises at least one guide line 64, provided with insertion channels 66, for example two, to provide an axis of vertical insertion Y1 of the permanent bearing structures P to be driven or bored into the ground (FIG. 5).

In other variants, the frame for guiding and positioning piles 62 comprises two guide lines 64, one positioned above the other, each one provided with corresponding insertion channels 66, for example three, wherein the central insertion channels 66 of each guide line 64 are coaxial in order to provide an axis of vertical insertion Y1 of the permanent bearing structures P to be driven or bored into the ground, while the lateral insertion channels 66 of the lower guide line 64 are positioned on an axis that is offset with respect to the lateral insertion channels 66 of the upper guide line 64, in order to provide an inclined axis of insertion Y2, inclined by a certain desired degree, of the permanent bearing structures P to be driven or bored into the ground (FIG. 6).

The main structure 12 can comprise a service platform 68 where it is possible to position any type of auxiliary equipment whatsoever, such as, for example, pile drivers, drills, caissons for the disposal of excavated materials or other material required for the progress of the engineering work O.

The service structure 68 can therefore be served and supplied by the one or more gantry cranes 26.

With reference to FIG. 7, each rest and slide unit 28 comprises at least upper roller units 70 which can be associated with the main structure 12 in correspondence with sliders 13 and are configured for the longitudinal movement of the main structure 12.

In possible variants, each rest and slide unit 28 comprises rotation bases 78, configured to vary the angle between the main structure 12 and the engineering work O under construction.

In possible variants, each rest and slide unit 28 can comprise under-roller units 72 which can be associated with a rest beam 76 in correspondence with respective sliders 77. The rest beam 76 is disposed transversely along the longitudinal development of the main structure 12 and is associated with at least one permanent bearing structure P.

In possible variants, each transverse rest beam 76 can be equipped with two or more hydraulic engagement/disengagement and/or adjustment cylinders 74 (FIG. 4). Each rest unit 28 can also be configured to be positioned on the top of the permanent bearing structure P or on structures placed thereon, for example, on a pier cap (FIG. 3).

The plant 10 can comprise movement means (not shown) configured to make the plant 10 advance along the engineering work O under construction. The movement means can be “step by step” hydraulic systems, or continuous towing systems, or “capstan” or “wind/unwind” type winches. Such movement means can, by means of a contrast with at least one rest and slide unit 28 attached to the permanent structures P, allow the sliding of the main structure 12 on the same rest and slide unit 28.

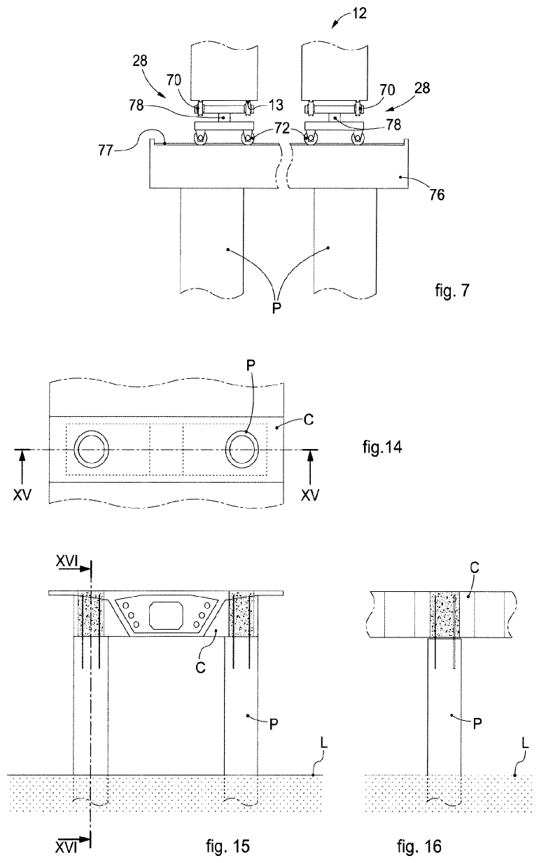

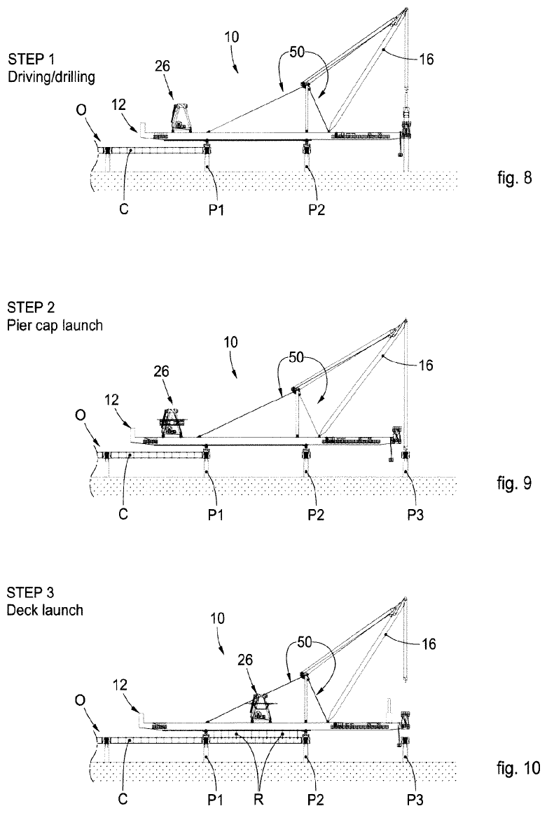

With reference to FIGS. 8-13, the invention describes a method for the construction of engineering works O such as viaducts, bridges, quays, wharfs or suchlike, operating exclusively from the work under construction both on dry surfaces and also on aqueous extensions such as rivers, lakes, seas, etc.

For the sole purpose of facilitating understanding, the description of the method refers to the construction of a segmental bridge; however, we must specify that the method can be applicable from the very beginning of the construction of the engineering work.

The operation of the plant 10 described heretofore, which also defines the steps of the method for the construction of engineering works O, is as follows.

In order to plant and/or construct permanent bearing structures P in the ground by means of driving/boring, the plant 10 rests on the pairs of permanent bearing structures P, in this case piers P1 and P2, respectively penultimate and last (FIG. 8), by means of rest and slide units 28, and the front part is cantilevered by a desired distance suitable for the bay span to be obtained.

Once one pier P3 is firmly positioned in the ground (FIG. 9), one proceeds with the positioning or launching of the pier cap on top of the pier P3. In the rear part of the plant 10, the gantry crane 26 can in the meantime receive the segments C to be moved toward the central part.

Each segment C transported by the gantry crane 26 is used for the launch of the deck (FIG. 10) between the piers P1 and P2, wherein each segment C is positioned by the main structure 12 by means of hanging lines R.

Once the segmental structure between the piers P1 and P2 has been consolidated, and after the plant 10 has retracted, a rest unit 28 is positioned on the top of the pier P3 (FIG. 11).

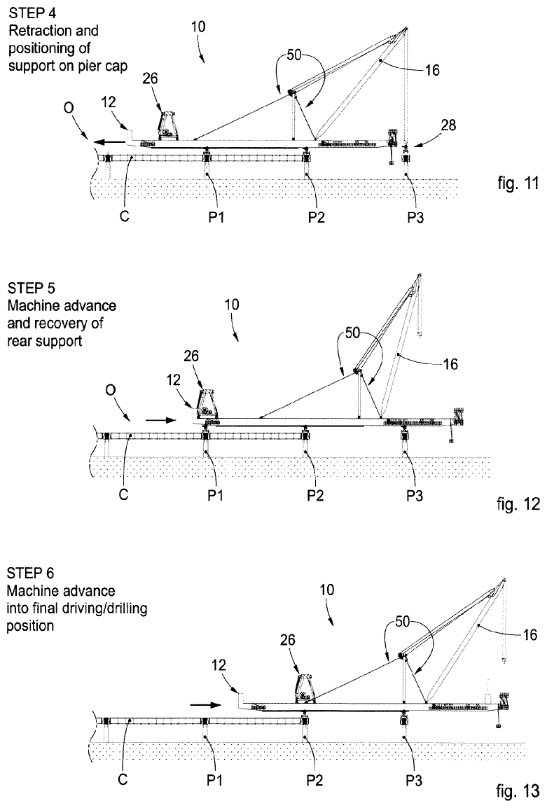

The plant 10 can then advance by finding support on the pier P3 (FIG. 12). The rest unit 28 associated with the pier P1, and therefore no longer necessary, can be recovered by the gantry crane 26 and temporarily parked to be used in the next advance.

The advance of the plant 10 proceeds until the front part is cantilevered by a distance suitable to plant a subsequent pier (FIG. 13) and the cycle restarts from the driving/boring of the pier.

With reference to FIGS. 14-16, the present invention also concerns a variant of the construction methodology of the state of the art for the construction of permanent structures with prefabricated and mating segments which consists in directly integrating, by means of on site casting of modest sizes, the pier head segment C with the permanent bearing structure P consisting of two piles/pier, bored or driven. The construction methodology described is particularly convenient when adopted together with the plant 10 for the construction of engineering works previously described, since it allows a decisive optimization of construction times. The modest quantities of concrete to be cast on site allow, in fact, to use materials with high characteristics that reach the required strengths in a very short time. In addition, the complete elimination of the structural element for connecting the pier piles (pier cap) also allows significant savings on the quantities of materials.

1. Plant (10) for the cantilevered construction of engineering works (O) comprising a main structure (12) configured to rest, during use, on at least part of said engineering work (O), wherein it comprises a derrick crane (14) constrained to, and integrated with, said main structure (12).

2. Plant (10) as in claim 1, wherein said derrick crane (14) comprises an arm (16) provided with a lower end (18) associated with the main structure (12) and with an opposite free upper end (20), at least one support structure (22) with vertical development constrained to the main structure (12), and swing cables (24) that associate said arm (16) with the at least one support structure (22).

3. Plant (10) as in claim 2, wherein said arm (16) is associated with said main structure (12) by connection means (38), in particular articulated connection means, more in particular hinge or pivoting means configured to allow said arm (16) to rotate around an axis of rotation (X).

4. Plant (10) as in claim 2, wherein said at least one support structure (22) is stiffened to said main structure (12) by means of stiffening structures (50).

5. Plant (10) as in claim 1, wherein it comprises one, or more, preferably a pair of gantry cranes (26) associated, so as to be sliding, with said main structure (12).

6. Plant (10) as in claim 2, wherein said arm (16) and said at least one support structure (22) have a gantry-type geometry so as to provide a gap to allow the passage of said one or more gantry cranes (26).

7. Plant (10) as in claim 1, wherein said main structure (12) is configured to be mobile with respect to the engineering work (O).

8. Plant (10) as in claim 7, wherein said main structure (12) comprises two or more rest and slide units (28) to be associated with at least two permanent bearing structures (P) of said engineering work (O), each of said two or more rest and slide units (28) comprising at least upper roller units (70) which can be associated with said main structure (12) in correspondence with sliders (13) and configured for the longitudinal movement of said main structure (12), rotation bases (78) configured to vary the angle between said main structure (12) and said engineering work (O) under construction, and under-roller units (72) configured for the transverse movement, which can be associated with a rest beam (76) in correspondence with respective sliders (77), wherein said rest beam (76) is disposed transversely along the longitudinal development of said main structure (12) and is associated with at least said one permanent bearing structure (P).

9. Method for the cantilevered construction of engineering works (O) which provides, on site, to position a main structure (12) cantilevered with respect to said engineering work (O), wherein it provides to erect/build permanent bearing structures (P) by means of a derrick crane (14) constrained to, and integrated with, said main structure (12).

10. Method as in claim 9, wherein it provides to make said main structure (12) slide on said permanent bearing structures (P).
